(19) United States
(12) Patent Application Publication
(10) Pub. No.: US 2007/0294240 A1
(43) Pub. Date: Dec. 20, 2007

(54) Intent based search

(75) Inventors: Mackenzie Steele, Bellevue, WA (US); Imran Aziz, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/448,646

(22) Filed: Jun. 7, 2006

(51) Int. Cl. G06F 17/30

(52) U.S. Cl. 707/5

(57) ABSTRACT

A system, a method and computer-readable media for locating and presenting relevant documents in response to a search query. Classification tags are assigned to electronic documents. Information is extracted from the documents. In response to a user search query, a set of relevant documents is identified, and an intent is derived and assigned to the search query. A presentation is generated for presenting the relevant documents. The presentation includes information extracted from the relevant documents. The presented information is formatted in accordance with a format associated with the assigned intent.

### BACKGROUND

The Internet has vast amounts of information distributed over a multitude of computers, hence providing users with large amounts of information on various topics. Other communication networks, such as intranets and extranets, may also provide a sizeable quantity of diverse information. Although large amounts of information may be available on a network, finding desired information may not be easy or fast.

Search engines have been developed to address the problem of finding desired information on a network. A conventional search engine includes a crawler (also called a spider or bot) that visits an electronic document on a network, “reads” it, and then follows links to other electronic documents within a Web site. The crawler returns to the Web site on a regular basis to look for changes. An index, which is another part of the search engine, stores information regarding the electronic documents that the crawler finds. In response to one or more user-specified search terms, the search engine returns a list of network locations (e.g., uniform resource locators (URLs)) and metadata that the search engine has determined include electronic documents relating to the user-specified search terms. Some search engines provide categories of information (e.g., news, web, images, etc.) and categories within these categories for selection by the user, who can thus focus on an area of interest.

Search engine software generally ranks the electronic documents that fulfill a submitted search request in accordance with their calculated relevance and provides a means for displaying search results to the user according to their rank. A typical relevance ranking is a relative estimate of the likelihood that an electronic document at a given network location is related to the user-specified search terms in comparison to other electronic documents. For example, a conventional search engine may provide a relevance ranking based on the number of times a particular search term appears in an electronic document, or based on its placement in the electronic document (e.g., a term appearing in the title is often deemed more important than the term appearing at the end of the electronic document), etc. Link analysis, anchor-text analysis, web page structure analysis, the use of a key term listing, and the URL text are other known techniques for ranking web pages and other hyperlinked documents.

Currently available search engines, however, are generally limited to ranking search results according to relevancy to search terms. Unfortunately, the highest-ranking results may not correspond to the user's intended area of search. For example, a user entering the search term “Saturn” when looking for a car may be presented information on the planet Saturn. Even if the query indicates that the user is interested in automobiles, the search query may not indicate whether the user intends to buy a car, to research available cars or to find a dealership address. In short, the search terms themselves may not indicate a user's intent when making the query. Indeed, ambiguity in a user's specified query may reduce the relevance of the generated search results and frustrate the user's ability to find desired information.

### SUMMARY

The present invention provides systems and methods for locating and presenting relevant documents in response to a search query. Classification tags are assigned to electronic documents. For example, the tags may be assigned to Web pages stored by a search engine. Information is extracted from the documents. In one embodiment, the extracted information is based on which tags are assigned to a document. For example, a Web page may have a tag indicating that the page offers a product for sale, and thus, the extracted information for this page may include the product name and price. In response to a user search query, a set of relevant documents is identified, and an intent is derived from the search query. For example, the intent maybe be derived from a user interaction that indicates the user's intent when making the search query. A presentation is generated from information extracted from the relevant documents. The presented information may be formatted in accordance with the assigned intent.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWING

The present invention is described in detail below with reference to the attached drawing figures, wherein:

FIG. 1 is a block diagram of an exemplary network environment suitable for use in implementing embodiments of the present invention;

FIG. 2 is a block diagram illustrating a system that provides search results to a user in accordance with one embodiment of the present invention;

FIG. 3 illustrates a method in accordance with one embodiment of the present invention for storing documents in an index;

FIG. 4 illustrates a method in accordance with one embodiment of the present invention for identifying documents of interest in response to a search query; and

FIGS. 5A-5C are screen displays of a graphical user interface in accordance with one embodiment of the present invention in which search results are presented to a user.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

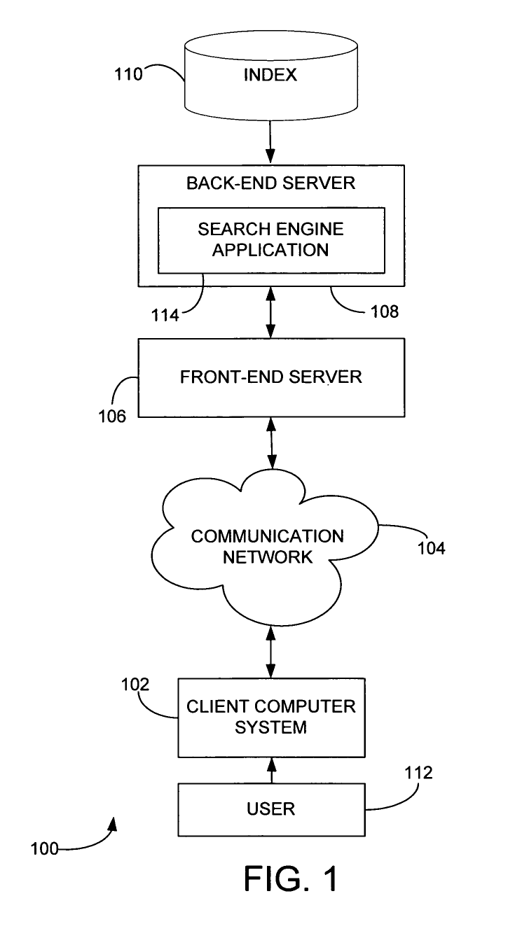

Referring initially to FIG. 1 in particular, an exemplary network environment for implementing the present invention is shown and designated generally as network environment 100. Network environment 100 is but one example of a suitable environment and is not intended to suggest any limitation as to the scope of use or functionality of the invention. Neither should the network environment 100 be interpreted as having any dependency or requirement relating to any one or combination of elements illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, specialty computing devices, servers, etc. The invention may also be practiced in distributed computing environments where tasks are performed by remote-processing devices that are linked through a communications network.

Referring now to FIG. 1, a client 102 is coupled to a data communication network 104, such as the Internet (or the World Wide Web). One or more servers communicate with the client 102 via the network 104 using a protocol such as Hypertext Transfer Protocol (HTTP), a protocol commonly used on the Internet to exchange information. In the illustrated embodiment, a front-end server 106 and a back-end server 108 (e.g., web server or network server) are coupled to the network 104. The client 102 employs the network 104, the front-end server 106 and the back-end server 108 to access Web page data stored, for example, in a central data index (index) 110.

Embodiments of the invention provide searching for relevant data by permitting search results to be displayed to a user 112 in response to a user-specified search request (e.g., a search query). In one embodiment, the user 112 uses the client 102 to input a search request including one or more terms concerning a particular topic of interest for which the user 112 would like to identify relevant electronic documents (e.g., Web pages). For example, the front-end server 106 may be responsive to the client 102 for authenticating the user 112 and redirecting the request from the user 112 to the back-end server 108.

The back-end server 108 may process a submitted query using the index 110. In this manner, the back-end server 108 may retrieve data for electronic documents (i.e., search results) that may be relevant to the user. The index 110 contains information regarding electronic documents such as Web pages available via the Internet. Further, the index 110 may include a variety of other data associated with the electronic documents such as location (e.g., links, or URLs), metatags, text, and document category. In the example of FIG. 1, the network is described in the context of dispersing search results and displaying the dispersed search results to the user 112 via the client 102. Notably, although the front-end server 106 and the back-end server 108 are described as different components, it is to be understood that a single server could perform the functions of both.

A search engine application (application) 114 is executed by the back-end server 108 to identify web pages and the like (i.e., electronic documents) in response to the search request received from the client 102. More specifically, the application 114 identifies relevant documents from the index 110 that correspond to the one or more terms included in the search request and selects the most relevant web pages to be displayed to the user 112 via the client 102.

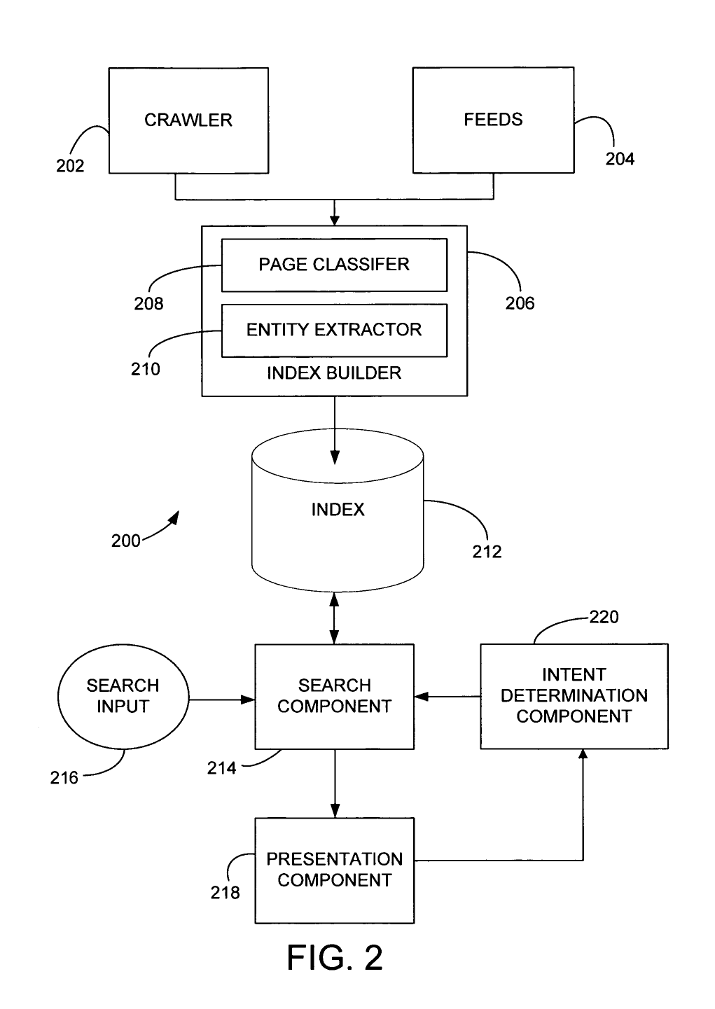

FIG. 2 illustrates a system 200 for providing search results to a user. The system 200 includes two sources of information, a web crawler 202 and content feeds 204. The web crawler 202 may be a program that browses the World Wide Web in a methodical, automated manner. The web crawler 202, for example, may be used to create copies of electronic documents available on the network (i.e., Web pages) for later processing by a search engine. Also, the web crawler 202 may be used to gather specific types of information from Web pages. Such web crawlers are known in the art. While the web crawler 202 seeks information from the network, the feeds 204 receive information provided by a merchant or other third party. For example, the feeds 204 may include commercial offers having a known format provided by a merchant. A variety of techniques exist in the art for a party to communicate their content in a feed of structured data.

The information gathered by the web crawler 202 and received by the feeds 204 may be submitted to an index builder 206. The index builder 206 may perform a variety of tasks necessary to index and store the information. For example, the index builder 206 includes a page classifier 208. The page classifier 208 may be configured to assign classification tags to the various documents received from the web crawler 202 and the feeds 204. In one embodiment, Web pages received from the web crawler 202 may be divided into a variety of subclasses based on a page's content. For example, Web pages with buying controls (e.g., “Buy buttons”) may allow the page to be tagged with a transactional tag. As another example, pages may offer information about a local business, restaurant or service. These pages may be tagged with a “local” tag to indicate a regional relevance for the page. Indeed, a wide variety of classification tags may be used by the page classifier 208 to divide the pages by type. In one embodiment, data is extracted from a Web page for evaluation by the page classifier 208. Using statistical models, the page classifier 208 may leverage a rule set in association with support vector machines to determine the tags to be associated with the Web pages. As will be appreciated by those skilled in the art, a variety of techniques exist for classifying documents with statistical models.

The index builder 206 also includes an entity extractor 210, which is configured to generate metadata from information extracted from the tagged documents. In one embodiment, the extracted metadata is dependent upon the page's type (i.e., which classification tags have been assigned to the page). For example, a page may describe a particular product and be tagged as a “product” page. The extracted metadata for such a product page may include the price, product name, image and other salient attributes present on the page. As a further example, a “reviews” page may extract a rating and a summary for various reviewed products/content. In one embodiment, for each type of document, the entity extractor 210 builds a visual DOM (Document Object Model) tree that can identify records on a page and cluster across these records to identify and extract common fields. In this manner, a format (or structure) for the metadata may be generated for the various document types. As will be appreciated by those skilled in the art, by gleaming metadata from documents based on the document type, the metadata may be tailored to maximize usefulness to a user evaluating search results.

The classification tags and the metadata may be stored along with the copies of the documents in an index 212. The index 212 may contain a variety of data associated with the electronic documents, such as document text, location, metadata, text, and tags. In short, the index 212 may contain data useful for a search operation to identify documents relevant to a query.

In one embodiment, the index 212 may include tags representing a one or more confidence measures for indicating how useful a page is to one or more respective user intents. These tags may be the classification tags generated by the page classifier 208 and/or may be generated with reference to the classification tags and the metadata. For example, a “research” intent may be associated with a document containing a product's review and metadata associated with this review. As another example, the index 212 may store a tag indicating a “shopping” intent with a document having a “buy” button and metadata indicating pricing information. As demonstrated by these examples, the intent tags do not necessarily define the content of a document. Rather the intent tags generally relate to how a document is likely be used by a user. As will be appreciated by those skilled in the art, a variety of intent-based tags and formatted metadata may reside along with the documents in the index 212.

The system 200 also includes a search component 214. The search component 214 is configured to receive a user search input 216 and to interact with the index 212 so as to identify a set of relevant documents responsive to the search input 216. Because the index 212 provides metadata and tags indicating an association between documents and potential user intents derived from the documents, the search component 214 may leverage this intent-based information. For example, the search component 214 may aggregate (i.e., group) the various documents by their related intents. In this manner, the intent tags in the result set may be identified, and the search component 214 may determine how well various results serve user intent in different situations.

The search component 214 may further be configured to generate a presentation for display to the user. This presentation may be presented by a presentation component 218. In one embodiment, the presentation is presented via the Internet as a Web page. Because the search input 216 may not adequately indicate a user's intent when making the query, the presentation may include visual elements to aid the system 200 in identifying such user intent.

In one embodiment, the user may be presented with metadata from documents associated with various intents. Further, the user may be presented actions that may be performed with regard to the presented results. These actions may be a function of a page's type and available metadata. For example, “Get directions to this business” may be an available action for a page identified as a “local business.” The presentation may also include elements that explicitly identify potential intents. For example, the presentation may list intents for user selections. In one embodiment, the presentation may ask, “Are you looking to Shop, Research or For Local Listing?” By exposing actions and controls, the presentation offers hints as to what additional tools and services are available. In this manner, the system 200 may cluster actions and types by intent and present controls that allow the user to efficiently indicate their content of interest.

The system 200 also includes an intent determination component 220 for determining the user's intent. The intent determination component 220 may determine which of the identified intents most accurately matches a user's search query. Such a determination may be made based on user inputs to the displayed presentation. For example, the search input 216 may include the term “mouse.” In this instance, the identified intents may relate to a computer mouse and to an animal mouse. The user may select a visual element indicating their intended interest is a computer mouse. Accordingly, the intent determination component 220 may infer that the search term “mouse” relates only to a computer mouse, not any animals. Such an identified intent may be communicated to the search component 214 so that different results and rankings can be exposed based on this intent. Further, targeted metadata, actions and advertisements may be presented by the presentation component 218 based on the identified intent.

In one embodiment, the intent determination component 220 refines the identified intent as the user continues to interact with the system. Based on the tags in the results set, a vertical search experience may be suggested to the user. A vertical search experience is a search over a subset of documents with a clear commonality. Since the search is scoped to documents of a certain type, additional features and functionality that leverage that commonality can be added to make it easier for the user to narrow their field of interest. For example, a user expressing an intent to purchase a car may be interested in either purchasing a used car from an Internet dealer, finding the address of a new car dealer in their area or searching classified ads. The intent determination component 220 may seek to determine which of these options (or more specific intents) the user desires. Once the intent is further refined, the search component 214 may provide the user the correct organized, vertical search experience. As will be appreciated by those skilled in the art, by providing an interface that allows the user to identify their intent and by leveraging the intent-based data in the index 212, the system 200 can capture the user's intent in a guided fashion and then provide a search experience with content, tools and ads targeted to that intent.

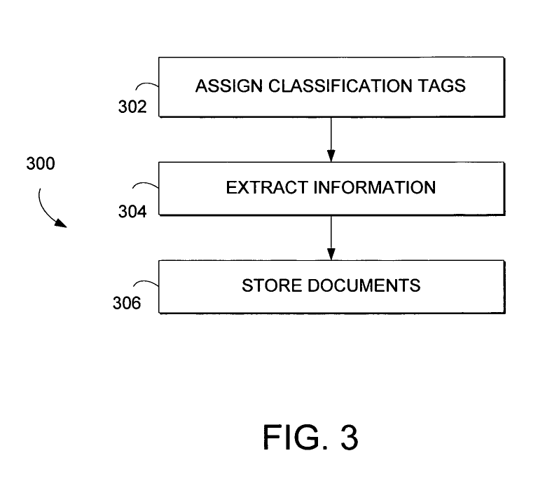

FIG. 3 illustrates a method 300 for storing documents in an index. The method 300, at 302, assigns classification tags to a variety of electronic documents. For example, the documents may be Web pages gathered by a web crawler, and the tags may be stored with copies the documents in by a search engine. Alternately, the documents may reside in a local data store, and the method 300 may be associated with a local search utility. The classification tags may indicate any number of type-classifications that may be associated with a document. In one embodiment, machine learning and pattern recognition technologies are utilized to assign the tags to the documents. In this manner, a large number of the documents may be efficiently tagged in an automated fashion.

At 304, the method 300 extracts information from the electronic documents. For example, the extracted information may serve as metadata accompanying the electronic documents in a file store or an index. A variety of information may be extracted at 304. In one embodiment, the extracted information is selected based on a document's classification tags. In this embodiment, the extracted metadata may be formatted in accordance with the content available on the Web page. For example, a tag may indicate that a Web page contains a job listing. For each of such Web pages, the extracted metadata may include the job title and salary range. So the most salient information for job seekers may be stored as metadata along with a job listing Web site. The method 300, at 306, stores the documents in an index along with the extracted information and/or the classification tags.

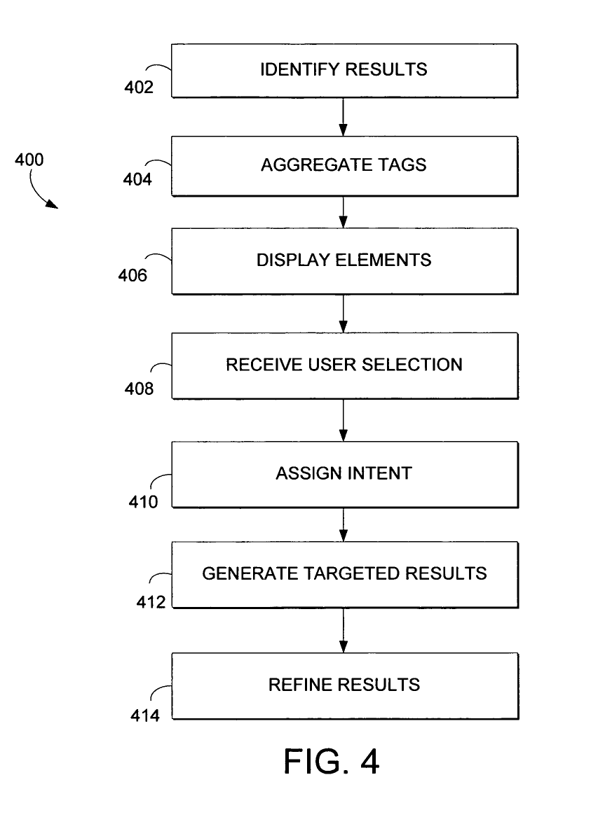

FIG. 4 illustrates a method 400 for identifying documents of interest in response to a search query. The method 400, at 402, identifies search results in response to a user query. For example, a user may input the query to a client-based search utility or to an Internet search engine. In this example, the search engine's front-end server may receive this query. The search engine may then search an index of electronic documents and return the most relevant results. Those skilled in the art will appreciate that there are numerous techniques for generating a set of documents responsive to a search query.

Once the set of responsive documents are generated, the method 400 aggregates the tags associated with the responsive documents at 404. In one embodiment, these tags may represent the potential intents of the user when making the query. Based on these tags, it may be determined how well the responsive documents serve a user's intent in different situations. For example, various documents in the result set may have tags indicating a strong relevance to serving a user that intends to purchase a certain product.

The method 400, at 406, displays visual elements to the user. Any number of visual elements relevant to the search results may be displayed. In one embodiment, the aggregated tags are used in the selection of these elements. For example, the user may be presented elements associated with the aggregated tags. By selecting a visual element, the user may indicate their intended content of interest. For example, the user may be presented a listing of various tags for selection, and the listing might correspond to tags in the result, including possibly a subset of the aggregated tags. The user may also be presented search results, actions and/or metadata relevant to a portion of the tags.

User interaction with such visual elements may be used to determine the user's intent and, at 408, the method 400 receives a user's selection of a visual element. Based on this selection, the method 400 may assign an intent to the search query at 410. For example, a user may submit a search query with the term “Apple.” The visual elements presented in this example may relate to both Apple computers and the fruit apple. User selection of an element associated with the fruit apple will indicate the user's desire to view information on the fruit apple, not on an Apple computer. As will be appreciated by those skilled in the art, by exposing various results, controls and action corresponding to different potential user intents, the user may be afforded the ability to indicate their actual intent.

Based on the identified intent, the method 400, at 412, generates or refines targeted results for presentation to the user. In one embodiment, the presented results and/or their ranking depend on the identified intent. Further, the exposed metadata, controls and advertisements may also be targeted to the identified intent. Returning to the apple example, the user may be presented a variety of search results relating to fruit apples, and/or advertisements for fruit apples might be presented. The various visual elements in this presentation may be designed to further refine the user's intent. For example, various results may address the health benefits of eating apples, while other results may provide retailers selling apples. Upon user interaction with the results, the method 400, at 414, can further refine the results by identifying a more narrowly-tailored intent. In this manner, the user may be guided into a vertical search scenario allowing for a structured approach to efficiently locate desired and useful content.

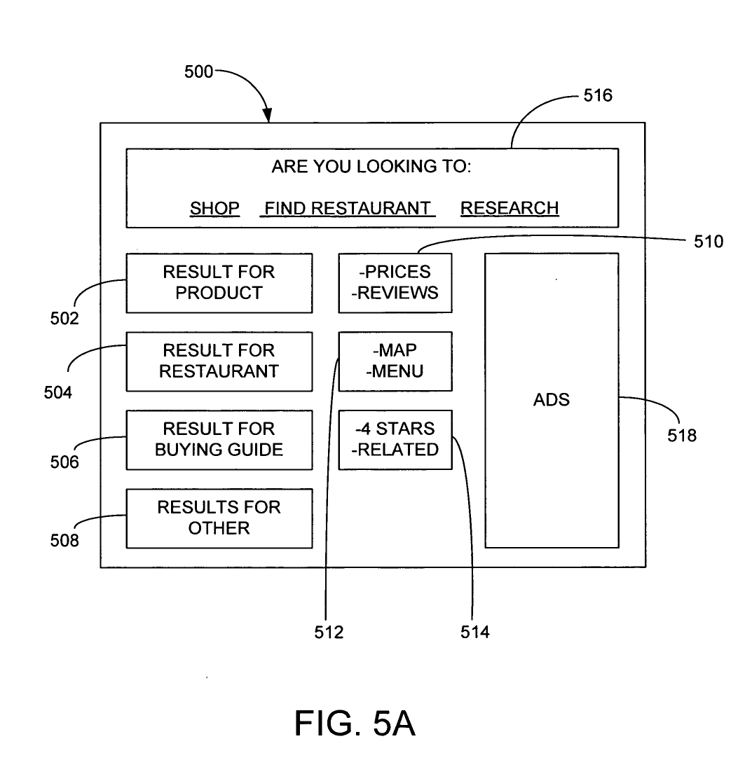

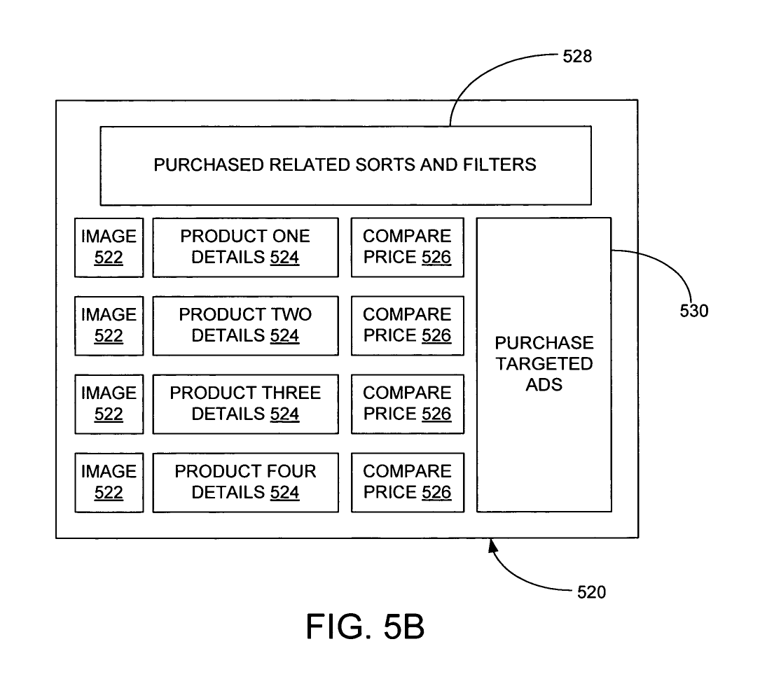

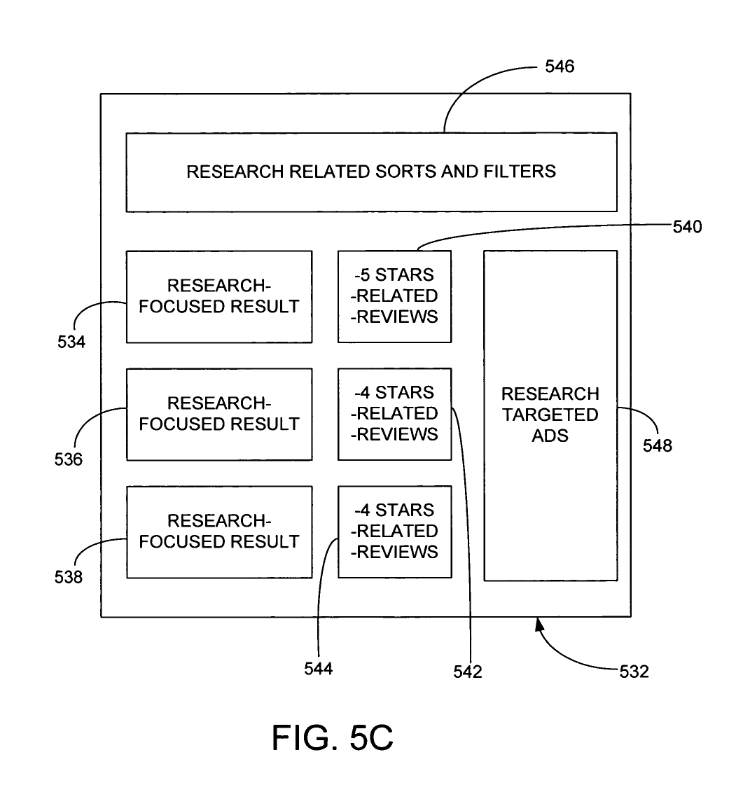

FIGS. 5A-5C present screen displays, which provide exemplary screen views in accordance with one embodiment of the present invention. In particular, the screen views are provided in response to user submission of the search query “steak grill.” Turning to FIG. 5A, a screen display 500 includes search results 502, 504, 506 and 508. For example, the results from the search query may include documents whose corresponding tags indicate the user's potential intents might be to make a purchase, to conduct research or to find a location. In one embodiment, a result for each of these potential intents is provided by the screen display 500. The search result 502, for example, provides a result relevant to the purchasing of a grill. The screen display 500 also includes metadata 510, 512 and 514. This metadata is provided to reinforce type and context for the respective search results 502, 504, 506 and 508. For example, the metadata 510 is provided along with the product purchasing result of the search result 502. The metadata 510 provides grill prices and reviews, i.e., metadata tailored to a purchasing intent. As another example, the search result 504 provides a result for a restaurant, while the accompanying metadata 512 provide a map to the restaurant and its menu. The metadata 510, 512 and 514 may be considered to represent “inline actions” that send a user to a more targeted view by capturing intent at the more specific, contextual level. The screen display 500 also includes an intent selection area 516. Using this area 516, the user may explicitly indicate which of the potential intents are relevant to their query. For example, the user may select the “shop” option if they are interested in purchasing grills. Finally, the screen display 500 includes an advertisement area 518 that displays advertisements that may be relevant to the search query.

FIG. 5B provides a screen display 520 that results from a user's selection of either “shop” or “prices” from the screen display 500. As these selections indicate a user's intent to purchase a grill, the screen display 520 provides results targeted to such a purchase intent. The screen display 520 includes images 522, product details 524 and product prices 526 for each of four different grills. These results have been ranked to emphasize product pages, and the exposed metadata is related to purchasing as well. The screen display 520 also includes sorts and filters 528 that provide purchase-specific sorts and filters to optimize the user's ability to efficiently find a product meeting their criteria. The screen display 520 includes a purchase-targeted advertisement area 530 that displays advertisements targeted to users seeking to purchase a grill.

FIG. 5C provides a screen display 532 that results from a user's selection of “research” from the screen display 500. As this selection indicates a user's intent to conduct research (or to research grills), the screen display 532 includes research-focused results 534, 536 and 538. These results now emphasize research pages and buying guides. The screen display 532 also includes metadata 540, 542 and 544, which present information from the various results. For example, the metadata 540 includes a five star ranking indicating this result strongly satisfies a research intent. The metadata 540 further includes other content related to research (e.g., reviews). The screen display 532 also includes sorts and filters 546 that provide research-specific sorts and filters. Finally, the screen display 532 includes a research-targeted advertisement area 548 that displays advertisements targeted to users researching grills.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. One or more computer-readable media having computer-useable instructions embodied thereon to perform a method for providing search results to a user, said method comprising:
generating displayable information including a search result responsive to a user search input, wherein the displayable information is formed by including elements of information extracted from documents corresponding to the search result, wherein at least a portion of said elements of information are associated with at least one of a plurality of intents;
receiving a user selection of one of said elements of information; and
using the intent associated with the selected element of information to generate revised displayable information including refined search results, wherein the revised displayable information is formed by elements of information extracted from said documents and identified as relevant to said intent associated with the selected element of information.

2. The media of claim 1, wherein at least a portion of said documents are web pages.

3. The media of claim 2, wherein said documents are stored by a search engine.

4. The media of claim 3, wherein said method further comprises assigning one or more classification tags to at least a portion of said documents, wherein said one or more classification tags indicate at least one of said plurality of intents.

5. The media of claim 4, wherein said method further comprises storing in a data store said documents along with said one or more classification tags and at least a portion of said elements of information extracted from documents.

6. The media of claim 5, wherein said method further comprises accessing said data store to generate said displayable information.

7. The media of claim 1, wherein said method further comprises re-ranking said documents in response to said user selection.

8. The media of claim 1, wherein said re-ranking selects said documents identified as relevant to said intent associated with the selected element of information.

9. A system for locating and presenting relevant documents to a user, comprising:
a page classifier configured to assign one or more classification tags to at least a portion of one or more documents, wherein said one or more classification tags indicate at least one of a plurality of intents;
an entity extractor for extracting information from at least a portion of said one or more documents, wherein said extracted information is selected in accordance with one or more information formats associated with at least one of said plurality of intents;
a search component for selecting a set of documents from said one or more documents in response to a search query;
an intent determination component configured to determine an intent from said plurality of intents for assignment to said search query; and
a presentation component configured to generate a presentation that displays at least a portion of said set of documents that include a classification tag indicating the determined intent, wherein said presentation includes at least a portion of said information extracted from the displayed documents and formatted in accordance with the information format associated with said determined intent.

10. The system of claim 9, wherein said entity extractor is further configured to separate HTML and meta information from at least a portion of said one or more documents.

11. The system of claim 9, wherein said system further comprises an index for storing said one or more classification tags and said extracted information along with said one or more documents.

12. The system of claim 11, wherein said search component is configured to access said index in response to said search query.

13. The system of claim 9, wherein said presentation component is further configured to utilize said determined intent in selecting one or more advertisements for display in said presentation.

14. The system of claim 9, wherein said intent determination component selects said determined intent in response to user selection of a visual element associated with said determined intent.

15. One or more computer-readable media having computer-useable instructions embodied thereon to perform a method for presenting search results relevant to a search input, said method comprising:
identifying a plurality of documents responsive to said search input, wherein at least a portion of said plurality of documents include one or more classification tags indicating at least one of a plurality of intents;
transmitting to a user information a display including a plurality of visual elements, wherein at least a portion of said visual elements are associated with at least one of said plurality of intents;
receiving a user selection of one of said plurality of visual elements;
assigning one of said plurality of intents associated with the selected visual element to said search input; and
generating search results for presentation to the user by displaying metadata from at least a portion of said plurality of documents, wherein said metadata is generated in accordance with said assigned intent.

16. The media of claim 15, wherein said search input is a user query to an Internet search engine.

17. The media of claim 15, wherein at least a portion of said plurality of visual elements indicate actions associated with one or more of said plurality of intents.

18. The media of claim 15, wherein said generating includes targeting advertisements by utilizing said assigned intent.

19. The media of claim 15, wherein said method further comprises refining said search results in response to one or more user inputs indicating an intent of said user.

20. The media of claim 15, wherein at least a portion of said plurality of intents is selected from the group consisting of a shopping intent and a research intent.
